(19) United States
(12) Patent Application Publication
(10) Pub. No.: US 2015/0039487 A1
(43) Pub. Date: Feb. 5, 2015

(54) SYSTEMS AND METHODS FOR INVESTABLE DELEVERING

(71) Applicant: National Association of Real Estate Investment Trusts, Washington, DC (US)

(72) Inventor: Bradford Case, McLean, VA (US)

(73) Assignee: National Association of Real Estate Investment Trusts, Washington, DC (US)

(21) Appl. No.: 13/956,583

(22) Filed: Aug. 1, 2013

(51) Int. Cl. G06Q 40/04

(52) U.S. Cl. CPC G06Q 40/04
USPC 705/37

(57) ABSTRACT

The present disclosure is directed toward generating indexes of unlevered asset returns based on the returns of constituents that employ leverage in the return-generating process, without exposing investors to significant tracking error. Data an amount of debt, cost of debt, implied market capitalization, and relative weights are compiled for each constituent of an index of returns of entities employing leverage. Additionally, return data are compiled for each exchange-traded product producing returns relevant to the cost of leverage employed by at least one of the constituents. Using the collected data, absolute weights of each constituent and each exchange traded product in an index of unlevered asset returns are determined. The index of unlevered asset returns may then be generated according to the constituents, the exchange-traded products, and the absolute weights.

### BACKGROUND

Growing quantities of commercial property assets are being held by publicly traded securitized real estate companies, known as Real Estate Investment Trusts (REITs). Public stock exchanges are generally regarded to be more efficient and liquid than private property markets, in which real estate assets trade directly in privately negotiated transactions. REITs are typically levered, employing anywhere from zero percent debt to over fifty percent debt in their capital structures. Although returns on investments in REITs reflect the returns of the properties owned by the REITs, the use of leverage makes REIT returns generally greater and more volatile than the returns on the underlying properties. To correct for the greater returns and volatility of a REIT-based index and produce more accurate data regarding property returns, returns measured by a REIT-based index may be delevered.

Delevering can be applied to any investment whose returns are derived from an underlying asset or set of assets through an intermediary that applies leverage. Examples may include equity REITs, whose returns are based on properties owned by the REIT; mortgage REITs, whose returns are based on mortgages or mortgage-backed securities owned by the REIT; stock in any other corporation, master limited partnership, or other entity whose returns are based on the assets owned by the entity; asset-based securities, whose returns are based on mortgages, loans, receivables, or other assets included in the security; or mutual funds or exchange-traded funds (ETFs), whose returns are based on the securities owned by the fund or ETF.

The use of leverage entails combining equity capital with debt capital (that is, borrowing money) and using the combined capital to acquire assets, so that the returns generated by the assets acquired using combined capital exceed the returns that would have been generated by assets acquired using equity capital only. Conversely, delevering entails diverting some equity capital (that is, lending money), so that the (levered) returns generated by the remaining equity capital equal the returns that would have been generated by the total equity capital if invested without leverage. Borrowing money requires making payments on the added (borrowed) capital; conversely, lending money earns payments on the diverted (lent) capital.

An index computed by combining the (levered) returns of several constituents that employ leverage may be delevered by first delevering the returns of individual constituents before combining the delevered returns. Levered returns of individual constituents may be delevered by collecting data on the amount and cost of leverage used by each constituent (e.g., as determined through annual 10K forms submitted to the Securities and Exchange Commission (SEC)) and applying the Weighted Average Cost of Debt (WACC) accounting identity. Investors can make investments whose returns are intended to track delevered returns by investing in entities that employ leverage while simultaneously making fixed-income investments in an amount equal to the amount of debt employed by each company, with the fixed-income investments designed to earn returns equal to each entity's cost of debt.

This method, however, exposes the investor to significant tracking error risk, meaning that the returns produced through the delevering process may differ substantially from the unlevered returns on underlying assets as measured by the delevered index, because it is generally very difficult to identify fixed-income investments with return characteristics that match any individual constituent's cost of leverage, and because fixed-income investments are generally not liquid enough to adjust exposures when the constituent's use of leverage changes. The presence of significant tracking error risk effectively eliminates the investability of returns delevered in this way. There is a need for an improved delevering method to reduce tracking error risk and provide meaningful data regarding the returns of assets owned by entities that use debt in their capital structures.

### SUMMARY

Rather than delevering the returns of individual constituents before combining delevered returns, which can expose the investor to significant tracking error risk, returns measured by an index based on levered constituent returns may be delevered by collecting data on the aggregate amount and average cost of leverage used collectively by the constituents and making fixed-income investments in the same aggregate amount, with the fixed-income investments designed to earn returns equal to the average cost of debt. As used herein, constituents are entities (1) whose returns are derived from an underlying asset or set of assets, (2) that employ leverage in the return-generating process, and (3) whose returns may be combined with those of other constituents to produce an index. Examples may include equity REITs, whose returns are based on properties owned by the REIT; mortgage REITs, whose returns are based on mortgages or mortgage-backed securities owned by the REIT; stock in any other corporation, master limited partnership, or other entity whose returns are based on the assets owned by the entity; asset-based securities, whose returns are based on mortgages, loans, receivables, or other assets included in the security; or mutual funds or exchange-traded funds (ETFs), whose returns are based on the securities owned by the fund or ETF.

In some implementations, the aggregate amount and average cost of leverage employed by constituents is determined by collecting data for each constituent from publicly available sources (e.g., 10-K forms submitted periodically to the SEC) and computing the sum of constituent-level debt and the weighted average cost of constituent-level debt. In some implementations, the fixed-income investments designed to earn returns equal to the average cost of debt are determined by collecting data on the average returns of exchange-traded products such as mutual funds or ETFs and conducting a regression analysis to identify a relationship between average cost of leverage and returns of exchange-traded products. In some examples, the exchange-traded products employed in conducting such a regression analysis include mutual funds or ETFs selected for liquidity and other characteristics that minimize tracking error risk. For example, regression analysis may be conducted on exchange-traded products for which data covering a threshold period of time is available (e.g., a period of time considered long enough to estimate the relationship between yields and constituent cost of debt). In another example, regression analysis may be conducted on exchange-traded products for which the average daily dollar trading volume exceeds a predetermined threshold determined (e.g., by professionals in the industry) to be sizeable enough to make it unlikely that a trade of a given size on any given day would significantly affect the share price of the exchange-traded product.

In some implementations, the delevering is accomplished by computing weights on selected exchange-traded products based on the results of the regression analysis, along with weights on levered constituents such that capital invested in accordance with the weights will produce aggregate returns substantially replicating the aggregated unlevered returns of assets owned by the constituents.

In one aspect, the present disclosure relates to a method including identifying, by a processor of a computing device, at least one constituent of an index, where one or more constituents of the at least one constituent are identified as employing leverage in the investment process, and the index is based at least in part on returns of the at least one constituent. The method may include identifying, by the processor, at least one exchange-traded product, where each exchange-traded product of the at least one exchange-traded product is identified as producing returns relevant to a cost of leverage employed by one or more constituents of the at least one constituent. The method may include collecting, for each constituent of the at least one constituent of the index: (i) debt data regarding an amount of debt employed in the investment process leading to the returns of the respective constituent, (ii) cost of debt data regarding a cost of debt employed in the investment process leading to the returns of the respective constituent, (iii) implied market capitalization data regarding an implied market capitalization of the respective constituent, and (iv) relative weight data regarding a relative weight of the respective constituent in the index based on returns of the at least one constituent. The method may include determining, by the processor, for each constituent of the at least one constituent of the index, a respective absolute weight, where the respective absolute weight is based at least in part on the respective relative weight data, the respective implied market capitalization data, and the respective debt data. The method may include collecting, for each exchange-traded product of the at least one exchange-traded product, returns data regarding returns of the respective exchange-traded product. The method may include determining, by the processor, for each exchange-traded product of the at least one exchange-traded product, (a) a respective relative weight, where the respective relative weight is based at least in part on the returns data of the respective exchange-traded product and the cost of debt of one or more constituents of the at least one constituent, and (b) a respective absolute weight, where the respective absolute weight is based at least in part on the respective relative weight and a sum of absolute weights of the at least one constituent. The method may include providing, for index generation purposes, a) the absolute weight of each exchange-traded product of the at least one exchange-traded product, and b) the absolute weight of each constituent of the at least one constituent.

In some embodiments, a first constituent of the at least one constituent is selected from a group consisting of: equity REIT and mortgage REIT. A first exchange-traded product of the at least one exchange-traded product may be selected from a group consisting of: mutual fund and exchange-traded fund. Collecting, for each constituent of the at least one constituent may include: collecting, at a first frequency, the debt data, collecting, at a second frequency, the cost of debt data, collecting, at a third frequency, the implied market capitalization data, and collecting, at a fourth frequency, the relative weight data. The first frequency, the second frequency, the third frequency, and the fourth frequency may be a same frequency.

In some embodiments, at least a portion of the one or more exchange-traded products are identified based in part upon availability of historical returns data covering at least a threshold period of time. At least the portion of the one or more exchange-traded products may be identified based further in part upon an average daily dollar trading volume exceeding a predetermined threshold value. Collecting, for each constituent of the at least one constituent of the index may include collecting, via a network, from one or more separate computing systems.

In some embodiments, collecting, for each constituent of the at least one constituent of the index includes collecting (v) returns data regarding returns of the respective constituent. Providing, for index generation purposes may include providing c) the respective returns data of each constituent of the at least one constituent, and d) the respective returns data of each exchange-traded product of the at least one exchange-traded product. Collecting the returns data regarding returns of each constituent may include collecting returns data on a periodic basis.

In one aspect, the present disclosure relates to a system including a processor and a memory having instructions stored thereon, where the instructions, when executed by the processor, cause the processor to identify at least one constituent of an index, where each constituent of the at least one constituent is identified as employing leverage in the investment process, and the index is based at least in part on returns of the at least one constituent. The instructions, when executed, may cause the processor to identify at least one exchange-traded product, where each exchange-traded product of the at least one exchange-traded product is identified as producing returns relevant to a cost of leverage employed by one or more constituents of the at least one constituent. The instructions, when executed, may cause the processor to determine, for each constituent of the at least one constituent of the index, a respective absolute weight, where the respective absolute weight is based at least in part on a) a relative weight of the respective constituent in the index, where the relative weight is based at least in part on returns of the at least one constituent, b) an implied market capitalization of the respective constituent, and c) an amount of debt employed in the investment process leading to the returns of the respective constituent. The instructions, when executed, may cause the processor to determine, for each exchange-traded product of the at least one exchange-traded product, (1) a respective relative weight, where the respective relative weight is based at least in part on a) returns of the respective exchange-traded product, and b) a cost of debt employed in the investment process leading to the returns of each constituent of one or more constituents associated with the respective exchange-traded product, and (2) a respective absolute weight, where the respective absolute weight is based at least in part on a) the respective relative weight, and b) a sum of the respective absolute weights of the at least one constituent. The instructions, when executed, may cause the processor to cause generation of an index of unlevered asset returns according to a) the absolute weight of each exchange-traded product of the at least one exchange-traded product, and b) the absolute weight of each constituent of the at least one constituent.

In some embodiments, the instructions, when executed, cause the processor to collect, for each exchange-traded product of the at least one exchange-traded product, exchange-traded product returns data regarding returns of the respective exchange-traded product, and collect, for each constituent of the at least one constituent, constituent returns data regarding returns of the respective constituent. The index may be generated according to the exchange-traded product returns data and the constituent returns data. The exchange-traded product returns data may include yield data.

In some embodiments, the instructions, when executed, cause the processor to, after causing generation of the index, cause publication of the index, in electronic form accessible via a network. Causing generation of the index of unlevered asset returns may include causing generation of the index consisting of a single constituent of the at least one constituent.

In one aspect, the present disclosure relates to a non-transitory computer readable medium having instructions stored thereon, where the instructions, when executed by a processor, cause the processor to identify at least one constituent of an index, where one or more constituents of the at least one constituent are identified as employing leverage in the investment process, and the index is based at least in part on returns of the at least one constituent. The instructions, when executed, may cause the processor to identify at least one exchange-traded product, where each exchange-traded product of the at least one exchange-traded product is identified as producing returns relevant to a cost of leverage employed by one or more constituents of the at least one constituent. The instructions, when executed, may cause the processor to collect, for each constituent of the at least one constituent of the index: (i) debt data regarding an amount of debt employed in the investment process leading to the returns of the respective constituent, (ii) cost of debt data regarding a cost of debt employed in the investment process leading to the returns of the respective constituent, (iii) implied market capitalization data regarding an implied market capitalization of the respective constituent, and (iv) relative weight data regarding a relative weight of the respective constituent in the index based on returns of the at least one constituent. The instructions, when executed, may cause the processor to determine, for each constituent of the at least one constituent of the index, a respective absolute weight, where the respective absolute weight is based at least in part on the respective relative weight data, the respective implied market capitalization data, and the respective debt data. The instructions, when executed, may cause the processor to collect, for each exchange-traded product of the at least one exchange-traded product, returns data regarding returns of the respective exchange-traded product. The instructions, when executed, may cause the processor to determine, for each exchange-traded product of the at least one exchange-traded product, a) a respective relative weight, where the respective relative weight is based at least in part on the returns data of the respective exchange-traded product and the cost of debt of one or more constituents of the at least one constituent, and b) a respective absolute weight, where the respective absolute weight is based at least in part on the respective relative weight and a sum of absolute weights of the at least one constituent. The instructions, when executed, may cause the processor to provide, for index generation purposes, a) the absolute weight of each exchange-traded product of the at least one exchange-traded product, and b) the absolute weight of each constituent of the at least one constituent.

In some embodiments, collecting, for each constituent of the at least one constituent includes collecting the debt data from a first computing system, and collecting the relative weight data from a second computing system, where the first computing system is different than the second computing system. The debt data may include a fixed rate debt component and a variable rate debt component. Collecting the cost of debt data may include collecting data regarding one or more payments made towards a debt held by the respective constituent, and determining the cost of debt data based at least in part upon the one or more payments and the debt data. Collecting the implied market capitalization data may include collecting a) a number of shares outstanding for the respective constituent and b) a price per share. Determining the implied market capitalization data may be based at least in part upon the number of shares outstanding and the price per share.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of a system for collecting data regarding assets and delevering investment allocations;

FIGS. 2A and 2B illustrate a flow chart of an example method for investible delevering;

FIG. 3 is a graph comparing levered returns to delevered returns;

FIG. 4 is a block diagram of an example network environment for investible delevering; and

FIG. 5 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

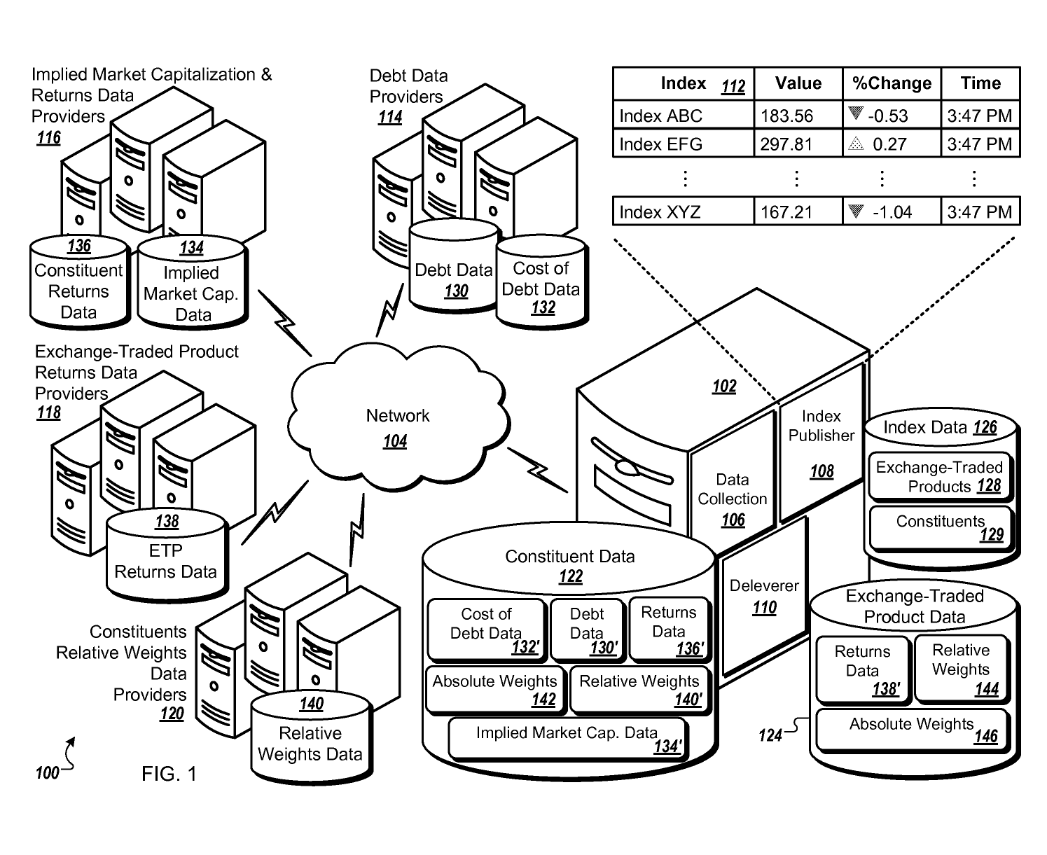

As illustrated in FIG. 1, a system 100 for investible delevering includes a server 102 including a data collection module 106 for collecting investment data regarding various investments (e.g., exchange-traded products 128 and constituents 129). A delevering module 110 of the server 102 generates unlevered asset returns based upon the collected investment data. The unlevered asset returns are used by an index publishing module 108 of the server 102 to generate an index 112 of unlevered asset returns.

In some implementations, the data collection module 106 obtains debt data 130 regarding an amount of debt held by the constituents 129 from one or more debt data providers 114. The debt data can vary significantly between the constituents 129. For example, debt held by a given constituent 129 may range from zero percent debt to over fifty percent debt in the capital structure of the given constituent 129. The debt data, for example, may be collected as a monetary (e.g., dollar) value. In another example, the monetary value may be determined through collecting data on percentage debt in the capital structure and calculating the monetary value based upon the percentage debt and total capital data. The debt data provider(s) 114 may include, in some examples, one or more constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), one or more data sources managed by data provision companies (e.g., Bloomberg L.P. of New York, N.Y., FactSet Research Systems Inc. of Norwalk, Conn., SNL Financial LC of Charlottesville, Va., etc.) and/or one or more data sources managed by the U.S. Securities and Exchange Commission (SEC). The data collection module 106, for example, may store the debt data 130 as debt data 130′ within a constituent data repository 122 (e.g., one or more computer readable storage mediums within the server 102 and/or accessible to the server 102). The data collection module 106 may collect the debt data 130 from the debt data provider(s) 114 on a periodic basis such as, in some examples, on a monthly or quarterly basis. The period of debt data collection, for example, may be based upon a period of publication of the debt data 130. In a particular example, a particular constituent debt data provider 114 may supply debt data 130 on a monthly basis, while the SEC may supply debt data 130 on a quarterly basis.

In some implementations, the data collection module 106 collects cost of debt data 132 regarding the cost of leverage used by each constituent 129. The cost of debt data 132, for example, may be derived through annual 10K forms submitted by the constituents 129 to the SEC. The cost of debt data 132, for example, may be represented as an interest rate. In another example, the interest rate may be derived based upon information regarding a monetary (e.g., dollar) value of payments made divided by total debt (e.g., the debt data 130). Similar to the debt data 130, the cost of debt data 132 may be collected from the debt data provider(s) 114 (e.g., same or different provider(s) 114 as those providing the debt data 130). The data collection module 106 may store the cost of debt data 132 as cost of debt data 132′ in the constituent data repository 122. The data collection module 106 may collect the cost of debt data 132 from the debt data provider(s) 114 on a periodic basis such as, in some examples, on a monthly or quarterly basis. The period of cost of debt data collection, for example, may be based upon a period of publication of the cost of debt data 132. In some implementations, the debt data 130 and cost of debt data 132 are collected at the same time.

In some implementations, the data collection module 106 obtains implied market capitalization data 134 (e.g., of the common shares outstanding plus operating partnership units of the constituents 129) from one or more implied market capitalization and returns data providers 116. In other implementations, implied market capitalization data can additionally represent preferred shares as equity (or, alternatively, as debt). In the example of Master Limited Partnerships (MLPs), a partnership share may replace the concept of common shares (and/or preferred shares and/or operating partnership units). The implied market capitalization and returns data provider(s) 116 may include, in some examples, one or more constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), and/or one or more data sources managed by data provision companies (e.g., Bloomberg L.P. of New York, N.Y., FactSet Research Systems Inc. of Norwalk, Conn., SNL Financial LC of Charlottesville, Va., etc.). The data collection module 106, for example, may store the implied market capitalization data 134 as implied market capitalization data 134′ within the constituent data repository 122. The data collection module 106 may collect the implied market capitalization data 134 from the implied market capitalization and returns data provider(s) 116 on a periodic basis such as, in some examples, on a monthly or quarterly basis. The period of implied market capitalization data collection, for example, may be based upon a period of publication of the implied market capitalization data 134. In a particular example, a first implied market capitalization and returns data provider 116 may supply implied market capitalization data 134 on a quarterly basis, while a second implied market capitalization and returns data provider 116 may supply implied market capitalization data 134 on a monthly basis.

In some implementations, the data collection module 106 obtains constituent returns data 136 regarding periodic investment returns (e.g., daily, monthly, weekly, etc.) of the constituents 129 from the implied market capitalization and returns data provider(s) 116. The data collection module 106, for example, may store the constituent returns data 136 as constituent returns data 136′ within the constituent data repository 122. The data collection module 106 may collect the constituent returns data 136 from the implied market capitalization and returns data provider(s) 116 on a periodic basis such as, in some examples, on a monthly or quarterly basis. The period of constituent returns data collection is not necessarily the same as the period of implied market capitalization data collection. For example, the data collection module 106 may collect implied market capitalization data 134 on a monthly basis and constituent returns data 136 on a daily basis.

In some implementations, the data collection module 106 obtains relative weights data 140 of the relative weights of the constituents 129 (e.g., within a particular index or particular indexes) from one or more constituent relative weights data providers 120. The constituent relative weights data provider(s) 120 may include, for example, one or more of servers employed by index publishers such as FTSE Group of London, UK, Dow Jones & Company of New York, N.Y., or Standard & Poor's of Boston, Mass. The data collection module 106, for example, may store the relative weights data 140 as relative weights data 140′ within the constituent data repository 122. The data collection module 106 may collect the relative weights data 140 from the constituent relative weights data provider(s) 120 on a periodic basis such as, in some examples, on a monthly or quarterly basis. The period of relative weights data collection, for example, may be based upon a period of publication of the relative weights data 140 (e.g., updates to the particular index). Although described in relation to the constituents 129, a portion of the relative weights data 140 may apply to constituents separate from the constituents 129. For example, tracking of historical data may include maintaining information regarding constituents which no longer exist or which have been removed from the particular index(es) of interest.

In some implementations, the data collection module 106 obtains returns data 138 regarding the investment returns of the exchange-traded products 128 from one or more exchange-traded product returns data providers 118. The exchange-traded products returns data 138, for example, represents the returns or yields of each of the exchange traded products. The exchange-traded product returns data provider(s) 118 may include, for example, one or more exchange-traded product provider-managed data sources (e.g., servers operated by exchange-traded funds (ETFs) whose returns are based on the securities owned by the fund or ETF, or other entity whose returns are based on the assets owned by the entity), and/or one or more data sources managed by data provision companies (e.g., Bloomberg L.P. of New York, N.Y., FactSet Research Systems Inc. of Norwalk, Conn., SNL Financial LC of Charlottesville, Va., etc.). The data collection module 106, for example, may store the exchange-traded product returns data 138 as ETP returns data 138′ within an exchange-traded product data repository 124. The data collection module 106 may collect the ETP returns data 138 from the exchange-traded product returns data provider(s) 118 on a periodic basis such as, in some examples, on a daily or weekly basis. The period of exchange-traded product returns data collection is not necessarily the same as the period of constituent returns data collection. For example, the data collection module 106 may collect ETP returns data 138 on an hourly basis and constituent returns data 136 on a daily basis.

Although illustrated as separate debt data provider(s) 114, implied market capitalization & returns data provider(s) (116), exchange-traded product returns data provider(s) 118, and constituents relative weights data provider(s) 120, in some implementations, the debt data 130, cost of debt data 132, implied market capitalization data 134, constituent returns data 136, exchange traded product returns data 138 and/or constituents relative weights data 140 may be collected from one or more shared sources. Additionally, in some implementations, a portion of one or more particular data collections, such as the debt data 130, may be collected from two or more sources. For example, a portion of the debt data 130 may be collected from a data provision company, while another portion of the debt data 130 (e.g., a portion unavailable via the data provision company) may be collected from one or more constituent-provided data sources.

Following data collection by the data collection module 106, in some implementations, the delevering module 110 accesses the constituent relative weights data 140′, the implied market capitalization data 134′, and the debt data 130′ to determine absolute weights 142 for constituents 129. The absolute weights 142, for example, represent delevered weights for each constituent 129 during a time period t from the relative (e.g., levered) weight 140′ of the same constituent 129 for the same time period.

In some implementations, the delevering module 110 accesses the exchange-traded product returns data 138′ and cost of debt data 132′ to determine relative weights 144 for exchange-traded products 128. In a particular example, the relative weights 144 may be determined such that the sum of all relative weights 144 equals 1, and no relative weight 144 is less than zero. The relative weights 144, in some implementations, is based further on the debt data 130′. In determining relative weights 144 based in part on the debt data 130′, the debt data 130′ may include constituents beyond those constituents considered to be within the index (e.g., beyond constituents 129). The debt data 130′, for example, may include data regarding constituents that no longer exist or constituents which are otherwise no longer included within the index.

In some implementations, the delevering module 110 accesses the constituent absolute weights 142 and the exchange-traded products relative weights 144 to determine exchange-traded product absolute weights 146. In determining the absolute weights 146, for example, the delevering module 110 may determine the sum of absolute weights of constituents included within a particular index based on returns of constituents which are employing leverage.

Once the constituent absolute weights 142, the exchange-traded product relative weights 144, and the exchange-traded product absolute weights 146 have been determined, in some implementations, the index publishing module 108 of the server 102 may produce the index 112 of unlevered asset returns based upon the constituent absolute weights data 142, the exchange-traded product absolute weights data 146, the constituent returns data 136′, and the exchange-traded product returns data 138′. The index 112, for example, may be used to make investment decisions, such as portfolio management decisions.

In other implementations (not illustrated), the constituent absolute weights data 142 and the exchange-traded product absolute weights data 146 are provided to a separate system. For example, the constituent absolute weights data 142 and the exchange-traded product absolute weights data 146 may be provided, via the network 104, to an index provider, where the constituent absolute weights data 142 and the exchange-traded product absolute weights data 146 can be combined with returns data (e.g., such as the constituent returns data 136′, and the exchange-traded product returns data 138′) to produce the index 112.

In some implementations, the index publisher 108 publishes the index 112 electronically, for example via a web site or mobile device application (e.g., for access via the network 104). The index 112 may be shared with other entities (e.g., subscribers and/or benchmarkers) such as, in some examples, one or more REITs, asset-based securities, mutual funds, ETFs, investors (e.g., pension funds), and/or data sources managed by data provision companies. In another example, financial (e.g., Wall Street) companies may subscribe for the right to write an over-the counter derivative contract with payoffs determined by the value of the index 112.

In some implementations, the index 112 is re-published periodically. For example, the values for the absolute weights 142, relative weights 144, and absolute weights 146 may be updated periodically based upon new information collected from the various data providers 114, 116, 118, and 120. In some examples, the index 112 is re-generated on a “real-time” basis (e.g., multiple times per day, as new constituent returns data 136′ is acquired), a daily basis, or a weekly basis. Although the index 112 may be republished relatively frequently, not all information will be re-calculated in preparation for index publication. For example, the exchange-traded product relative weights data 144 may be updated quarterly (e.g., in response to quarterly changes in constituent cost of debt data 132′ and/or exchange traded fund return data 138′). Alternatively, in another example, the exchange-traded product relative weights 144 may be calculated once and used for an extended period of time (e.g., six months, one year, etc.). The constituent absolute weights 142 and exchange-traded product absolute weights 146, in a further example, may be updated based upon receipt of new constituent relative weights data 140′ (e.g., on a monthly basis) and/or new constituent market cap data 134′(e.g., on a monthly basis). Other implementations are possible based upon the data obtained and calculated by the server 102 via the system 100.

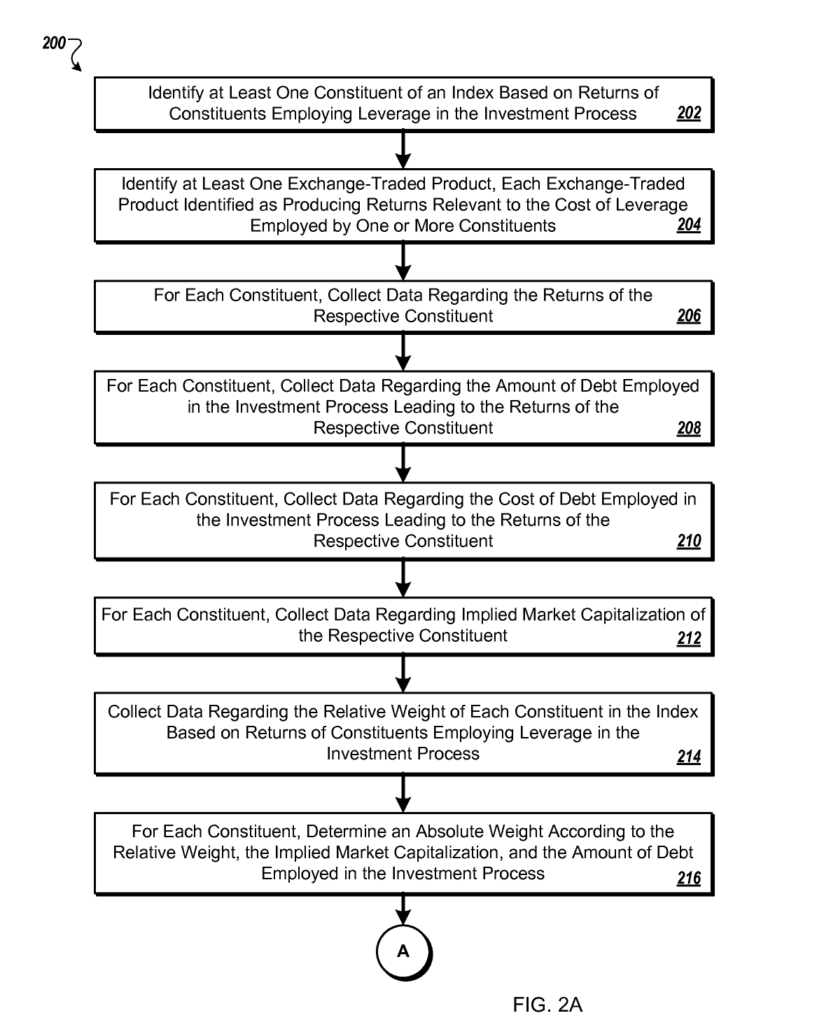

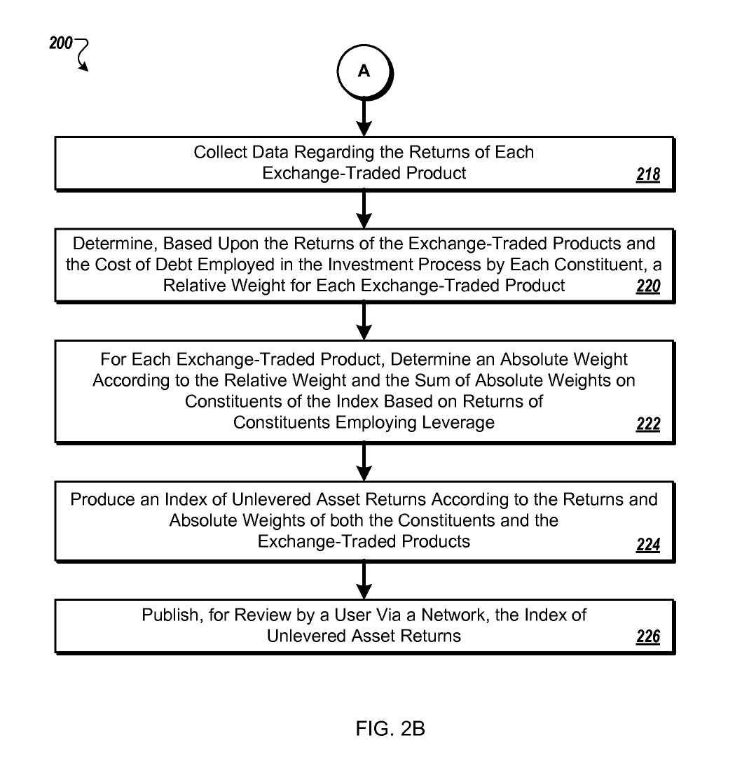

FIGS. 2A and 2B illustrate a flow chart of an example method 200 for producing an index of unlevered asset returns. Portions of the method 200, for example, may be performed by the server 102 of FIG. 1 to produce the index 112.

In some implementations, the method 200 begins with identifying at least one constituent of an index based on returns of constituents employing leverage in the investment process (202). The index is based at least in part on returns of at least one levered constituent. The levered constituent(s), in some examples, may include investments whose returns are derived from an underlying asset or set of assets through an intermediary that applies leverage such as, in some examples, equity REITs, mortgage REITs, and/or stock in any other corporation, master limited partnership, or other entity whose returns are based on the assets owned by the entity. Further examples of leveraged constituents include asset-based securities and mutual funds and/or ETFs whose returns are based on the securities owned by the mutual fund or ETF. Other constituents may exist within the index (e.g., constituents not employing leverage and/or constituents which employed leverage in the initial investment process but no longer carry debt associated with the leveraged investment process).

In some implementations, at least one exchange-traded product is identified as producing returns relevant to the cost of leverage employed by one or more of the constituents (204). The exchange-traded product(s), for example, may include one or more mutual funds and/or exchange-traded funds (ETFs). The at least one exchange-traded product, in some implementations, is selected in part based upon an availability of historical returns data covering at least a threshold period of time (e.g., five years). In some implementations, the at least one exchange-traded product is selected in part based upon an average daily trading volume (e.g., monetary value) exceeding a predetermined threshold (dollar) value. For example, the at least one exchange-traded product may be selected in part based upon the average daily trading volume being large enough that it is considered that it is unlikely that a trade of a given size on a given day would significantly affect the share price of the exchange-traded product.

In some implementations, data is collected for each constituent of the at least one constituent regarding the returns of the respective constituent (206). Constituent returns data may be collected via a network from one or more data sources such as, in some examples, one or more constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), and/or one or more data sources managed by data provision companies (e.g., Bloomberg L.P. of New York, N.Y., FactSet Research Systems Inc. of Norwalk, Conn., SNL Financial LC of Charlottesville, Va., etc.). The constituent returns data, for example, may be collected from the implied market capitalization and returns data providers 116 by the data collection module 106 of the server 102, as described in relation to FIG. 1. The constituent returns data may be collected on a periodic basis (e.g., daily, weekly, etc.). In some implementations, the constituent returns data is pushed to the system as updates are made available (e.g., potentially multiple times per day).

In some implementations, data regarding the amount of debt employed in the investment process leading to the returns of each constituent of the at least one constituent is collected (208). The constituent debt data, for example, may be collected as a monetary (e.g., dollar) value. In another example, the monetary value may be determined through collecting data on percentage debt in the capital structure and calculating the monetary value based upon the percentage debt and total capital data. The constituent debt data may be collected via a network from one or more data sources such as, in some examples, constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), one or more data sources managed by data provision companies (e.g., Bloomberg L.P. of New York, N.Y., FactSet Research Systems Inc. of Norwalk, Conn., SNL Financial LC of Charlottesville, Va., etc.) and/or one or more data sources managed by the U.S. Securities and Exchange Commission (SEC). The constituent debt data, for example, may be collected from the debt data providers 114 by the data collection module 106 of the server 102, as described in relation to FIG. 1. The constituent debt data may be collected on a periodic basis (e.g., monthly, quarterly, etc.). In a particular example, the amount of debt (e.g., in dollar value) held by constituent n during time period t may be expressed using one of the following equations:

TD_{n,t}=D^{fixed}_{n,t}+D^{variable}_{n,t} (1a)

TD_{n,t}=D^{short}_{n,t}+D^{long}_{n,t} (1b)

where D^{fixed}_{n,t} is the dollar amount of fixed-rate debt held by constituent n during time period t, D^{variable}_{n,t} is the dollar amount of variable-rate debt held by constituent n during time period t, D^{short}_{n,t} is the dollar amount of short-term debt held by constituent n during time period t, and D^{long}_{n,t} is the dollar amount of long-term debt held by constituent n during time period t.

In some implementations, data regarding the cost of debt employed in the investment process leading to the returns of each constituent of the at least one constituent is collected (210). The cost of debt data, for example, may be represented as an interest rate. In another example, the interest rate may be derived based upon information regarding a monetary (e.g., dollar) value of payments made divided by total debt (e.g., the debt data collected at step 208). The cost of debt data may be collected via a network from one or more data sources such as, in some examples, constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), one or more data sources managed by data provision companies (e.g., Bloomberg L.P. of New York, N.Y., FactSet Research Systems Inc. of Norwalk, Conn., SNL Financial LC of Charlottesville, Va., etc.) and/or one or more data sources managed by the U.S. Securities and Exchange Commission (SEC). The cost of debt data, for example, may be collected from the debt data providers 114 by the data collection module 106 of the server 102, as described in relation to FIG. 1. The cost of debt data may be collected on a periodic basis (e.g., monthly, quarterly, etc.). In some implementations, the cost of debt data is collected at the same time as the debt data of step 208. In a particular example, the cost of debt (e.g., expressed as an interest rate) held by constituent n during time period t may be expressed as follows:

CD_{n,t}=Payments_{n,t}/TD_{n,t} (2)

where Payments_{n,t} is the dollar amount of debt service payments made by constituent n during time period t.

In some implementations, data regarding an implied market capitalization of each constituent of the at least one constituent is collected (212). The implied market capitalization data, in one example, refers to the implied market capitalization of the common shares outstanding plus operating partnership units of the at least one constituent. In other examples, implied market capitalization data can additionally represent preferred shares as equity (or, alternatively, as debt). In the example of Master Limited Partnerships (MLPs), a partnership share may replace the concept of common shares (and/or preferred shares and/or operating partnership units). The implied market capitalization data may be collected via a network from one or more data sources such as, in some examples, one or more constituent-provided data sources (e.g., servers operated by real estate investment trusts (REITs), asset-based securities, mutual funds and/or or exchange-traded funds (ETFs) whose returns are based on the securities owned by the fund or ETF, or other entity whose returns are based on the assets owned by the entity), and/or one or more data sources managed by data provision companies (e.g., Bloomberg L.P. of New York, N.Y., FactSet Research Systems Inc. of Norwalk, Conn., SNL Financial LC of Charlottesville, Va., etc.). The implied market capitalization data, for example, may be collected from the implied market capitalization and returns data providers 116 by the data collection module 106 of the server 102, as described in relation to FIG. 1. The implied market capitalization data may be collected on a periodic basis (e.g., monthly, quarterly, etc.). In a particular example, the implied market capitalization (e.g., in dollar value) held by constituent n during time period t may be expressed as follows:

MC_{n,t}=Shares_{n,t}*P_{n,t} (3)

where Shares_{n,t} is the number of common equity shares outstanding for constituent n as of date t and P_{n,t} is the price per common equity share for constituent n as of date t.

In some implementations, data regarding a relative weight of each constituent of the at least one constituent within the index is collected (214). The constituent relative weight data may be collected via a network from one or more data sources such as, in some examples, one or more servers employed by index publishers such as FTSE Group of London, UK, Dow Jones & Company of New York, N.Y., or Standard & Poor's of Boston, Mass. The constituent relative weight data, for example, may be collected from the constituents relative weights data providers 120 by the data collection module 106 of the server 102, as described in relation to FIG. 1. The constituent relative weights data may be collected on a periodic basis (e.g., monthly, quarterly, etc.). Although described in relation to the levered constituents identified within step 202, a portion of the relative weights data 140 may apply to separate constituents. For example, tracking of historical data may include maintaining information regarding constituents which no longer exist or which have been removed from the particular index of interest. In a particular example, the relative weight (e.g., levered weight) of constituent n during time period t may be expressed as follows:

w^{L}_{n,t}=MC_{n,t}/Σₙ₌₁^{N}MC_{n,t} (4)

where Σₙ₌₁^{N}MC_{n,t} is the aggregate implied market capitalization of all constituents included in the index based on levered constituent returns.

In some implementations, for each constituent of the at least one constituent, an absolute weight is determined according to the respective relative weight, the respective implied market capitalization, and the respective amount of debt employed in the investment process (216). The absolute weights, for example, represent delevered weights for each constituent during a time period t from the relative (e.g., levered) weights (collected at step 214) of the same constituent for the same time period. In one example, the delevering module 110 of the server 102 may determine the absolute weights 142 according to the relative weights 140′, the implied market capitalization data 134′, and the debt data 130′. In a particular example, the absolute weight (e.g., delevered weight) w^{U}_{n,t} of constituent n during time period t may be determined using the following equation:

$${w}_{n , t}^{U} = {w}_{n , t}^{L} * ( 1 - \frac{{TD}_{n , t}}{{TD}_{n , t} + {MC}_{n , t}} ) \qquad ( 5 )$$

Turning to FIG. 2B, the method 200 continues, in some implementations, with collecting data regarding the returns of each exchange-traded product (218). The exchange-traded product returns data, for example, represents the returns or yields of each of the exchange traded products. The exchange-traded product returns data may be collected via a network from one or more data sources such as, in some examples, one or more exchange-traded product provider-managed data sources (e.g., servers operated by exchange-traded funds (ETFs) whose returns are based on the securities owned by the fund or ETF, or other entity whose returns are based on the assets owned by the entity), and/or one or more data sources managed by data provision companies (e.g., Bloomberg L.P. of New York, N.Y., FactSet Research Systems Inc. of Norwalk, Conn., SNL Financial LC of Charlottesville, Va., etc.). The exchange-traded product returns data may be collected, for example, from the exchange-traded product returns data providers 118 by the data collection module 106 of the server 102, as described in relation to FIG. 1. The exchange-traded product returns data may be collected on a periodic basis (e.g., real-time, daily, weekly, etc.). In a particular example, the exchange-traded product returns (yields) of exchange-traded product k during time period t may be expressed as follows:

R_{k,t}=Income_{k,t}/P_{k,t} (6)

where Income_{k,t}=income produced by exchange-traded product k during time period t and P_{k,t}=price per share of exchange-traded product k as of time t.

In some implementations, a relative weight for each exchange-traded product of the at least one exchange traded product is determined based upon the returns of the exchange-traded products and the cost of debt employed in the investment process by each constituent (220). In one example, the exchange-traded product relative weights may be determined such that the sum of all exchange-traded product relative weights equals 1, and no exchange-traded product relative weight is less than zero. The delevering module 110 of the server 102, for example, may determine the exchange-traded product relative weights 144 according to the exchange-traded product returns data 138′ and the cost of debt data 132′. In a particular example, the exchange-traded product relative weights may be determined as a k×1 vector β using the following equation:

β=(X′X)⁻¹X′y (7a)

where y is an n×1 vector in which each element is CD_{n,t} (2); X is an n×k vector in which each element is R_{k,t} (6)); and the elements of the k×1 vector β are constrained such that Σₖβₖ=1 and βₖ≧0∀k.

The exchange-traded product relative weights, in some implementations, are based further on the constituent debt data (e.g., collected at step 208). In determining exchange-traded product relative weights based in part on the constituent debt data, the constituent debt data may include constituents beyond those constituents considered to be within the index (e.g., beyond constituents identified in relation to step 202). The constituent debt data, for example, may include data regarding constituents that no longer exist or constituents which are otherwise no longer included within the index. In a particular example, the exchange-traded product relative weights may be determined as an alternative k×1 vector β using constituent debt data through the following equation:

β=(XΩ⁻¹′X)⁻¹X′Ω⁻¹y (7b)

where y is the n×1 vector in which each element is CD_{n,t} (2); X is the n×k vector in which each element is R_{k,t} (6); Ω is an n×n diagonal matrix in which each diagonal element is TD_{n,t} (1) and each off-diagonal element is zero; and the elements of the k×1 vector β are constrained such that Σₖβₖ=1 and βₖ≧0∀k.

In some implementations, an absolute weight for each exchange-traded product of the at least one exchange-traded product is determined according to the exchange-traded product relative weights and the sum of constituent absolute weights based on returns of constituents employing leverage (222). The delevering module 110 of server 102, for example, may determine the exchange-traded product absolute weights 146 according to the constituent absolute weights 142 and the exchange-traded product relative weights 144, as described in relation to FIG. 1. In determining the exchange-traded product absolute weights, for example, the delevering module may determine the sum of absolute weights of constituents included within a particular index based on returns of constituents which are employing leverage. In a particular example, the absolute weight w of exchange-traded product k at time t may be determined in view of the sum of absolute weights of constituents w^{U}_{n,t} (5) for each relative weight βₖ (7a or 7b) of the exchange-traded product k using the following equation:

w_{k,t}=(1−Σₙ₌₁^{N}w_{n,t}^{U})*βₖ (8)

In some implementations, an index of unlevered asset returns according to the returns and absolute weights of both the constituents and the exchange-traded products is produced (224). For example, as described in relation to FIG. 1, the index publishing module 108 of the server 102 may determine the index 112 based upon the constituent returns data 136′, the exchange-traded product returns data 138′, the constituent absolute weights 142, and the exchange-traded product absolute weights 146. The index includes the constituents identified at step 202. The index of unlevered asset returns, for example, may be used to make investment decisions, such as portfolio management decisions.

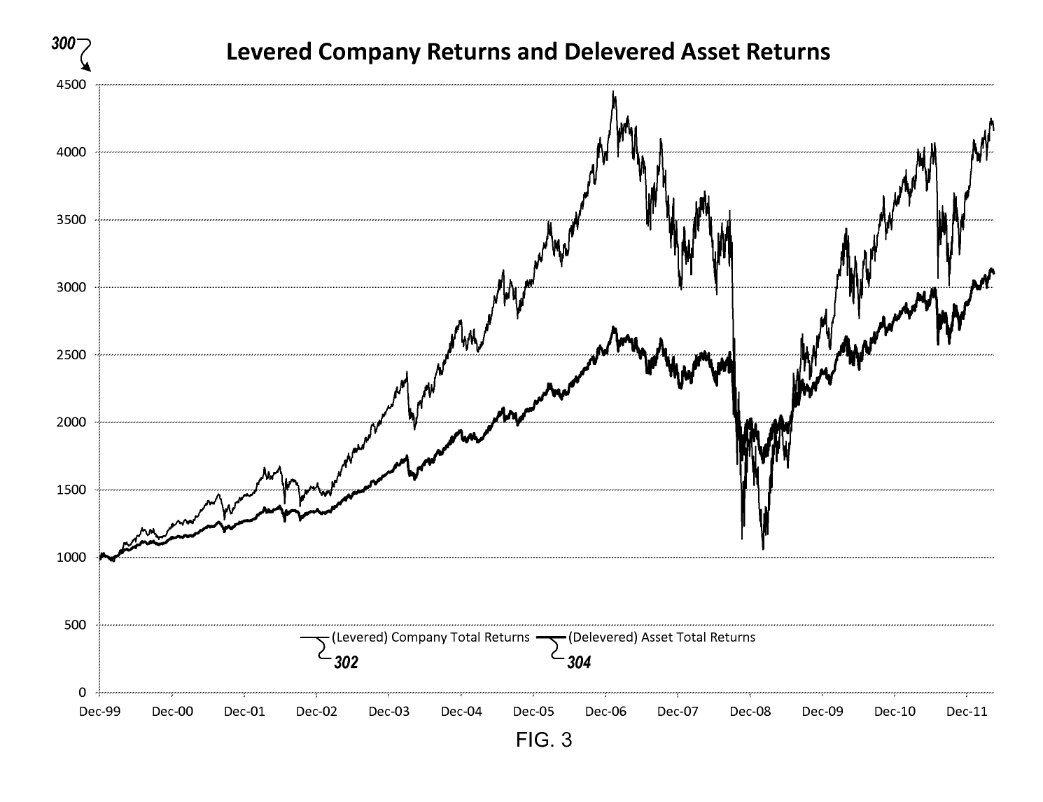

As illustration, turning to FIG. 3, a graph 300 demonstrates an example comparison between levered returns 302 and delevered returns 304 for a given company over a time period spanning December 1999 through December 2011. As may be seen through review of the graph 300, the delevered returns 304 are far less volatile than the levered returns 302. As explained previously, the use of leverage can cause the returns of levered constituents to be greater on average and more volatile than the returns on the underlying assets. To correct for the greater returns and volatility of an index including levered constituents, and produce more accurate data regarding asset returns, the returns may be delevered in a manner such as the method 200 describes.

Returning to FIG. 2B, in some implementations, the index of unlevered asset returns is published for review by a user via a network (226). In one example, the index publishing module 108 of server 102 may publish the index 112 electronically, for example via a web site or mobile device application (e.g., for access via the network 104), as described in relation to FIG. 1. The index may be shared with other entities (e.g., subscribers and/or benchmarkers) such as, in some examples, one or more REITs, asset-based securities, mutual funds, ETFs, investors (e.g., pension funds), and/or data sources managed by data provision companies. In another example, financial (e.g., Wall Street) companies may subscribe for the right to write an over-the counter derivative contract with payoffs determined by the value of the index.

Although the method 200 is described in relation to a particular series of steps, one or more steps may be executed in a different order, or two or more steps may be executed simultaneously. For example, collection of constituent returns data (208) may occur after determination of the constituent absolute weights (216). In some implementations, one or more steps may be removed from the method 200, or one or more steps may be added. In one example, rather than collecting constituent returns (206), generating the index of unlevered asset returns (224) and publishing the index for review (226), the method 200 may supply the constituent absolute weights (e.g., determined in step 216), the exchange-traded fund relative weights (e.g., determined in step 220), and the exchange-traded fund absolute weights (e.g., determined in step 222) to an external system (e.g., software module, separate software application, separate computing system, etc.), and the external system may use the information to produce an index of unlevered asset returns. In a second example, a step of re-publishing the index (e.g., based upon updated data captured via at least a partial data collection as described in one or more of steps 206, 208, 210, 212, 214, and 218) may be added after step 226 of publishing the index. Re-publication, for example, is described in relation to FIG. 1. Other variations of the method 200 are possible.

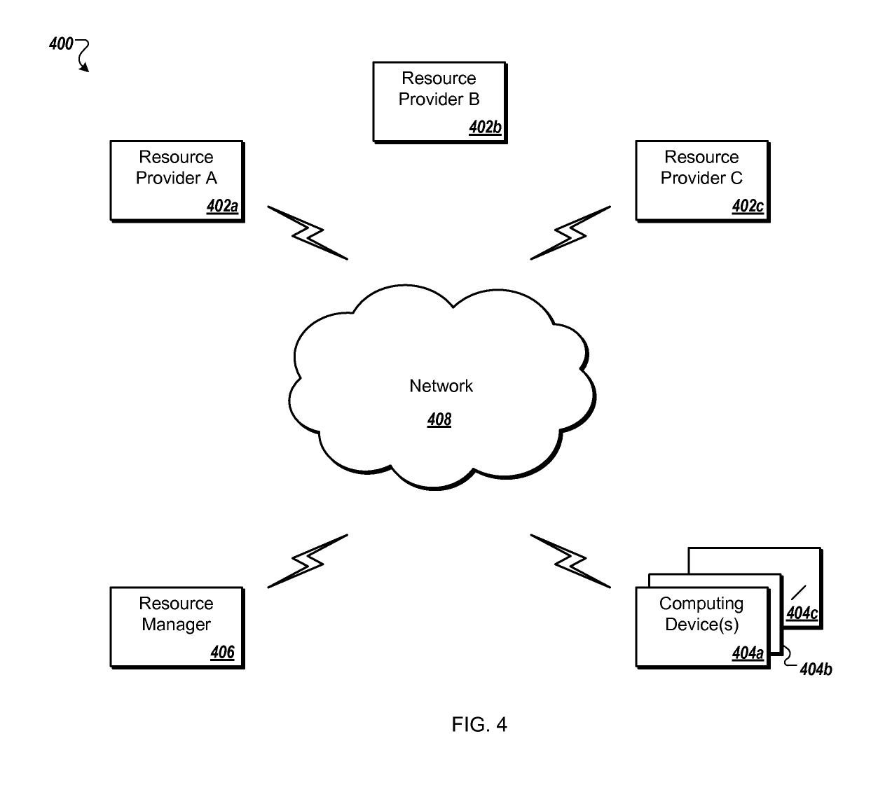

As shown in FIG. 4, an implementation of an exemplary cloud computing environment 400 for investible delevering is provided. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

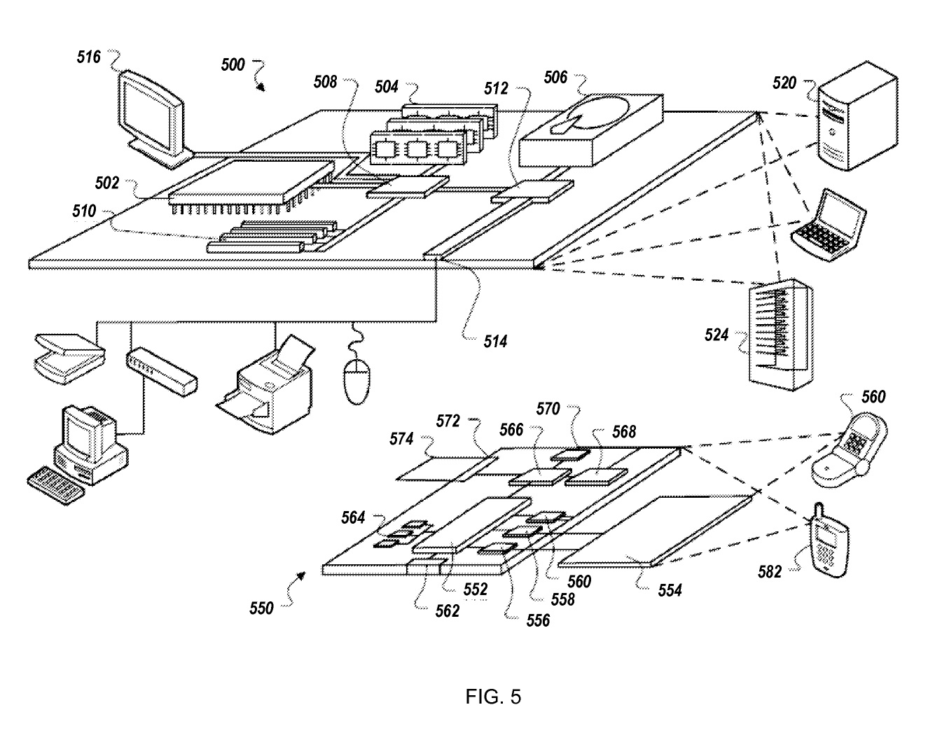

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for investible delivering are provided. Having described certain implementations of methods and apparatus for supporting investible delevering, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
identifying, by a processor of a computing device, at least one constituent of an index, wherein
one or more constituents of the at least one constituent are identified as employing leverage in the investment process, and
the index is based at least in part on returns of the at least one constituent;
identifying, by the processor, at least one exchange-traded product, wherein each exchange-traded product of the at least one exchange-traded product is identified as producing returns relevant to a cost of leverage employed by one or more constituents of the at least one constituent;
collecting, for each constituent of the at least one constituent of the index:
(i) debt data regarding an amount of debt employed in the investment process leading to the returns of the respective constituent,
(ii) cost of debt data regarding a cost of debt employed in the investment process leading to the returns of the respective constituent,
(iii) implied market capitalization data regarding an implied market capitalization of the respective constituent, and
(iv) relative weight data regarding a relative weight of the respective constituent in the index based on returns of the at least one constituent;
determining, by the processor, for each constituent of the at least one constituent of the index, a respective absolute weight, wherein the respective absolute weight is based at least in part on the respective relative weight data, the respective implied market capitalization data, and the respective debt data;
collecting, for each exchange-traded product of the at least one exchange-traded product, returns data regarding returns of the respective exchange-traded product;
determining, by the processor, for each exchange-traded product of the at least one exchange-traded product,
a respective relative weight, wherein the respective relative weight is based at least in part on the returns data of the respective exchange-traded product and the cost of debt of one or more constituents of the at least one constituent, and
a respective absolute weight, wherein the respective absolute weight is based at least in part on the respective relative weight and a sum of absolute weights of the at least one constituent; and
providing, for index generation purposes, a) the absolute weight of each exchange-traded product of the at least one exchange-traded product, and b) the absolute weight of each constituent of the at least one constituent.

2. The method of claim 1, wherein a first constituent of the at least one constituent is selected from a group consisting of: equity REIT and mortgage REIT.

3. The method of claim 1, wherein a first exchange-traded product of the at least one exchange-traded product is selected from a group consisting of: mutual fund and exchange-traded fund.

4. The method of claim 1, wherein collecting, for each constituent of the at least one constituent comprises:
collecting, at a first frequency, the debt data;
collecting, at a second frequency, the cost of debt data;
collecting, at a third frequency, the implied market capitalization data; and
collecting, at a fourth frequency, the relative weight data.

5. The method of claim 4, wherein the first frequency, the second frequency, the third frequency, and the fourth frequency are a same frequency.

6. The method of claim 1, wherein at least a portion of the one or more exchange-traded products are identified based in part upon availability of historical returns data covering at least a threshold period of time.

7. The method of claim 6, wherein at least the portion of the one or more exchange-traded products are identified based further in part upon an average daily dollar trading volume exceeding a predetermined threshold value.

8. The method of claim 1, wherein collecting, for each constituent of the at least one constituent of the index comprises collecting, via a network, from one or more separate computing systems.

9. The method of claim 1, wherein:
collecting, for each constituent of the at least one constituent of the index comprises collecting (v) returns data regarding returns of the respective constituent; and
providing, for index generation purposes comprises providing c) the respective returns data of each constituent of the at least one constituent, and d) the respective returns data of each exchange-traded product of the at least one exchange-traded product.

10. The method of claim 8, wherein collecting the returns data regarding returns of each constituent comprises collecting returns data on a periodic basis.

11. A system comprising:
a processor; and
a memory having instructions stored thereon, wherein the instructions, when executed by the processor, cause the processor to:
identify at least one constituent of an index, wherein
each constituent of the at least one constituent is identified as employing leverage in the investment process, and
the index is based at least in part on returns of the at least one constituent;
identify at least one exchange-traded product, wherein each exchange-traded product of the at least one exchange-traded product is identified as producing returns relevant to a cost of leverage employed by one or more constituents of the at least one constituent;
determine, for each constituent of the at least one constituent of the index, a respective absolute weight, wherein the respective absolute weight is based at least in part on
a) a relative weight of the respective constituent in the index, wherein the relative weight is based at least in part on returns of the at least one constituent,
b) an implied market capitalization of the respective constituent, and
c) an amount of debt employed in the investment process leading to the returns of the respective constituent;
determine, for each exchange-traded product of the at least one exchange-traded product,
a respective relative weight, wherein the respective relative weight is based at least in part on
a) returns of the respective exchange-traded product, and
b) a cost of debt employed in the investment process leading to the returns of each constituent of one or more constituents associated with the respective exchange-traded product, and
a respective absolute weight, wherein the respective absolute weight is based at least in part on
a) the respective relative weight, and
b) a sum of the respective absolute weights of the at least one constituent; and
cause generation of an index of unlevered asset returns according to a) the absolute weight of each exchange-traded product of the at least one exchange-traded product, and b) the absolute weight of each constituent of the at least one constituent.

12. The system of claim 11, wherein the instructions, when executed, cause the processor to:
collect, for each exchange-traded product of the at least one exchange-traded product, exchange-traded product returns data regarding returns of the respective exchange-traded product; and
collect, for each constituent of the at least one constituent, constituent returns data regarding returns of the respective constituent; wherein
the index is generated according to the exchange-traded product returns data and the constituent returns data.

13. The system of claim 12, wherein the exchange-traded product returns data comprises yield data.

14. The system of claim 11, wherein the instructions, when executed, cause the processor to, after causing generation of the index, cause publication of the index, in electronic form accessible via a network.

15. The system of claim 11, wherein causing generation of the index of unlevered asset returns comprises causing generation of the index consisting of a single constituent of the at least one constituent.

16. A non-transitory computer readable medium having instructions stored thereon, wherein the instructions, when executed by a processor, cause the processor to:
identify at least one constituent of an index, wherein
one or more constituents of the at least one constituent are identified as employing leverage in the investment process, and
the index is based at least in part on returns of the at least one constituent;
identify at least one exchange-traded product, wherein each exchange-traded product of the at least one exchange-traded product is identified as producing returns relevant to a cost of leverage employed by one or more constituents of the at least one constituent;
collect, for each constituent of the at least one constituent of the index:
(i) debt data regarding an amount of debt employed in the investment process leading to the returns of the respective constituent,
(ii) cost of debt data regarding a cost of debt employed in the investment process leading to the returns of the respective constituent,
(iii) implied market capitalization data regarding an implied market capitalization of the respective constituent, and
(iv) relative weight data regarding a relative weight of the respective constituent in the index based on returns of the at least one constituent;
determine, for each constituent of the at least one constituent of the index, a respective absolute weight, wherein the respective absolute weight is based at least in part on the respective relative weight data, the respective implied market capitalization data, and the respective debt data;
collect, for each exchange-traded product of the at least one exchange-traded product, returns data regarding returns of the respective exchange-traded product;
determine, for each exchange-traded product of the at least one exchange-traded product,
a respective relative weight, wherein the respective relative weight is based at least in part on the returns data of the respective exchange-traded product and the cost of debt of one or more constituents of the at least one constituent, and
a respective absolute weight, wherein the respective absolute weight is based at least in part on the respective relative weight and a sum of absolute weights of the at least one constituent; and
provide, for index generation purposes, a) the absolute weight of each exchange-traded product of the at least one exchange-traded product, and b) the absolute weight of each constituent of the at least one constituent.

17. The computer readable medium of claim 16, wherein collecting, for each constituent of the at least one constituent comprises collecting the debt data from a first computing system, and collecting the relative weight data from a second computing system, wherein the first computing system is different than the second computing system.

18. The computer readable medium of claim 16, wherein the debt data comprises a fixed rate debt component and a variable rate debt component.

19. The computer readable medium of claim 16, wherein collecting the cost of debt data comprises:
collecting data regarding one or more payments made towards a debt held by the respective constituent; and
determining the cost of debt data based at least in part upon the one or more payments and the debt data.

20. The computer readable medium of claim 16, wherein collecting the implied market capitalization data comprises:
collecting a) a number of shares outstanding for the respective constituent and b) a price per share; and
determining the implied market capitalization data based at least in part upon the number of shares outstanding and the price per share.
